(19) United States
(12) Patent Application Publication
(10) Pub. No.: US 2026/0249775 A1
(43) Pub. Date: Aug. 27, 2026

(54) TRUCK BED ACCESSORY RAIL MOUNTING SYSTEMS

(71) Applicant: Toyota Motor Engineering & Manufacturing North America, Inc., Plano, TX (US)

(72) Inventor: Robert Ditner, Howell, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/064,115

(22) Filed: Feb. 26, 2025

(51) Int. Cl. B60P 7/08

(52) U.S. Cl. CPC B60P 7/0815

(57) ABSTRACT

An accessory rail mounting system includes a truck bed, a first tie down, a second tie down, and an accessory rail. The truck bed includes a floor, a front wall, a first sidewall, and a second sidewall. The first tie down is fixed to the first sidewall. The second tie down is fixed to the second sidewall. The accessory rail having a first end and a second end opposite the first end. The accessory rail having a first latch at the first end and a second latch at the second end. The first latch and the second latch configured to releasably couple to the first tie down and the second tie down to releasably couple the accessory rail to the truck bed.

### TECHNICAL FIELD

The present specification generally relates to systems for mounting an accessory rail in a vehicle and, more specifically, to a system for mounting an accessory rail in a trunk bed that is attachable to a truck without the need of tooling and without damaging the truck bed.

### BACKGROUND

Trucks typically have truck beds in which cargo can be transported. However, such cargo may shift and move during transport. Various accessories, e.g., bike racks, cargo boxes, and the like, may be fixed to the truck bed to secure certain type of cargo within the truck bed. Installation and/or removal of such accessories, racks, and/or rails to support such accessories typically requires tooling and/or may subject the truck bed to damage. Accordingly, a need exists for improved structure to secure accessories to a truck bed without the need of tooling or causing damage to the truck bed.

### SUMMARY

In one embodiment, an accessory rail mounting system for mounting an accessory includes a truck bed including a floor, a front wall, a first sidewall, and a second sidewall. The accessory rail mounting system includes a first tie down fixed to the first sidewall. The accessory rail mounting system includes a second tie down fixed to the second sidewall. The accessory rail mounting system includes an accessory rail extending from a first end to a second end opposite the first end. The accessory rail has a first latch at the first end and a second latch at the second end. The first latch and the second latch are configured to releasably couple to the first tie down or the second tie down.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an accessory rail mounting system with an accessory rail for a vehicle in an uninstalled position, according to one or more embodiments shown and described herein;

FIG. 2 schematically depicts a top view of the accessory rail mounting system with the accessory rail for the vehicle in an installed position, according to one or more embodiments shown and described herein;

FIG. 3 schematically depicts a rear view of the accessory rail mounting system with the accessory rail in the installed position of FIG. 2, according to one or more embodiments shown and described herein;

FIG. 4 schematically depicts a top view of the accessory rail mounting system with the accessory rail at an another installed position, according to one or more embodiments shown and described herein; and

FIG. 5 schematically depicts a rear view of the accessory rail mounting system with the accessory rail at the installed position of FIG. 4, according to one or more embodiments shown and described herein.

### DETAILED DESCRIPTION

Embodiments described herein are directed to an accessory rail mounting system with an accessory rail having latches configured to releasably couple to tie downs fixed to sidewalls of a truck bed. The accessory rail mounting system allows a user to secure an accessory within the truck bed without the use of tooling or damaging the truck bed or accessory rail. Various embodiments of the accessory rail mounting system and the operation of the accessory rail mounting system are described in more detail herein. Whenever possible, the same reference numerals will be used throughout the drawings to refer to the same or like parts.

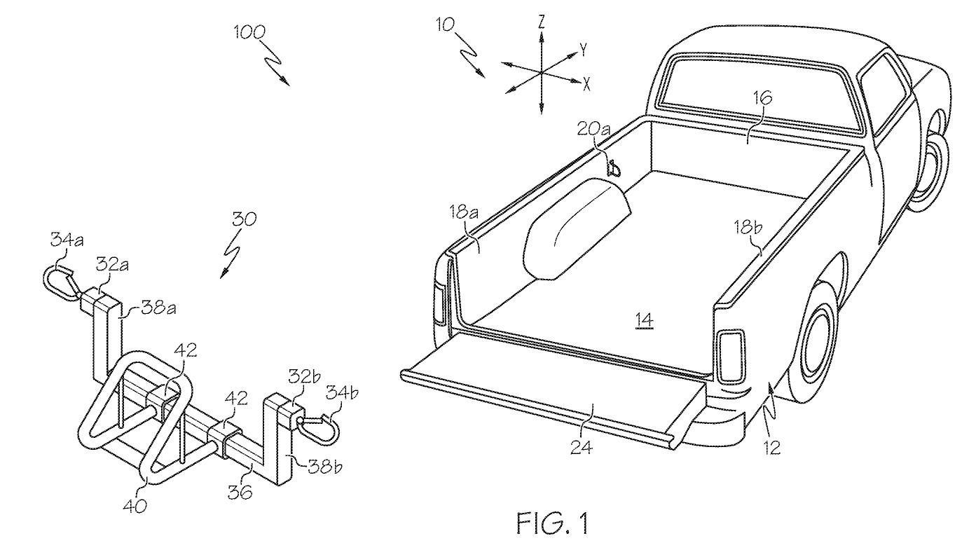

As used herein, the term “vehicle longitudinal direction” refers to the forward-rearward direction of the vehicle (i.e., in the +/- Y direction of the coordinate axes depicted in FIG. 1). The term “vehicle lateral direction” refers to the cross-vehicle direction (i.e., in the +/- X direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 10 and an accessory rail mounting system 100 are shown. The accessory mounting system 10 includes a truck bed 12 and an accessory rail 30. The truck bed 12 includes a first sidewall 18a and an opposite second sidewall 18b. The truck bed 12 includes a first tie down 20a fixed to the first sidewall 18a and a second tie down 20b fixed to the second sidewall 18b of the truck bed 12. The accessory rail 30 includes a first latch 34a and a second latch 34b. The first latch 34a is configured to releasably couple to the first tie down 20a and the second latch 34b is configured to releasably couple to the second tie down 20b.

The vehicle 10 may be a pick-up truck, or other suitable vehicle 10 than can support the truck bed 12. The vehicle 10 may be a passenger or commercial automobile. The vehicle 10 may include an electric, gas, or hybrid powertrain for propulsion. The vehicle 10 may be of a unibody construction in which a vehicle frame is unitary with a vehicle body (including frame rails, pillars, roof rails, etc.). As another example, the vehicle 10 may have a body-on-frame construction (also referred to as a cab-on-frame construction) in which the vehicle body and vehicle frame are separate components, i.e., are modular, and the vehicle body is supported on and affixed to the vehicle frame. Alternatively, the vehicle frame and vehicle body may have any suitable construction. The vehicle frame and vehicle body may be of any suitable material, for example, steel, aluminum, and/or fiber-reinforced plastic, etc. The vehicle body may define a passenger compartment to house occupants, if any, of the vehicle 10.

The truck bed 12 is included, for example, to support cargo for transportation by the vehicle 10. The truck bed 12 may be rearward of the passenger compartment. In other words, the passenger cabin may be forward of the truck bed 12 relative to a forward direction of the vehicle 10 and along a vehicle-longitudinal axis Y.

The truck bed 12 includes a floor 14, a front wall 16, the first sidewall 18a, and the second sidewall 18b. The truck bed 12, e.g., the floor 14, the front wall 16, the first sidewall 18a, and/or the second sidewall 18b may be formed of components of the vehicle frame and/or vehicle body. The truck bed 12, e.g., the floor 14, the front wall 16, the first sidewall 18a, and/or the second sidewall 18b may be fixed to, or otherwise supported by, components of the vehicle frame and/or vehicle body.

The front wall 16, the first sidewall 18a, and the second sidewall 18b may extend upward from the floor 14. The floor 14, the first sidewall 18a, and the second sidewall 18b may extend rearward from the front wall 16, e.g., away from the passenger cabin and towards a tailgate 24. The first sidewall 18a and the second sidewall 18b may be on opposite sides of the floor 14, e.g., along the vehicle lateral direction. The floor 14, the front wall 16, the first sidewall 18a, and the second sidewall 18b collectively define a cargo volume 22. The cargo volume 22 is a volume in which cargo may be disposed within the truck bed 12. The cargo volume 22 may be above the vehicle 10 floor 14 along the vehicle vertical direction, between the first sidewall 18a and the second sidewall 18b along the vehicle lateral direction, and between the front wall 16 and the tailgate 24 along the vehicle longitudinal direction. The tailgate 24 may be movable between an open position and a closed position, e.g., to increase ease in which cargo can be added or removed from cargo volume 22.

The floor 14, the front wall 16, the first sidewall 18a, and/or the second sidewall 18b may each include liners, e.g., to provide a robust surface for cargo placed in the truck bed 12. The liners may be monolithic. For the purposes of this disclosure, “monolithic” means a single-piece unit, i.e., a continuous piece of material without any fasteners, joints, welding, adhesives, etc., fixing multiple pieces to each other. For example, liners of the floor 14, the front wall 16, the first sidewall 18a, and/or the second sidewall 18b may be provided by a single molded structure. Alternately, one or more liners of the floor 14, the front wall 16, the first sidewall 18a, and/or the second sidewall 18b may be separate. The separate liners of the floor 14, the front wall 16, the first sidewall 18a, and/or the second sidewall 18b may be fixed to each other, e.g., with a fastener, adhesive, or the like.

The first tie down 20a and the second tie down 20b are included to provide attachment points, e.g., to secure cargo with the cargo volume 22. The first tie down 20a is fixed to the first sidewall 18a and the second tie down 20b is fixed to the second sidewall 18b, e.g., via fastener, threaded engagement, weld, or the like. The first tie down 20a and/or the second tie down 20b may be a loop or other suitable structure for engaging with the first latch 34a and the second latch 34b. The loop may be circular, oval, generally triangular, or other suitable shape. It is appreciated that the accessory rail mounting system 100 may include more than two tie downs with additional tie downs fixed to the first sidewall 18a, the second sidewall 18b, and/or the front wall 16.

The accessory rail 30 is included to provide structure to secure an accessory 40, i.e., a structure configured to secure, support or store an item, within the cargo volume 22, e.g., when such accessory 40 is not suited for attachment directly to the first tie down 20a, the second tie down 20b, or the like. For example and without limitation, the accessory 40 may be a wheel chock configured to support a wheel of a motorcycle, as shown in FIG. 1. Other non-limiting examples include structure configured to support or secure to a kayak, canoe, bicycle, or the like. Further non-limiting examples include structure configured to store tools, hunting equipment, camping equipment, or the like. The accessory rail 30 may be steel, aluminum, or any material of suitable strength to support the accessory 40 and/or other structure attached thereto, A cross-sectional shape of the accessory rail 30 may be tubular, square, round, or any suitable shape.

The accessory 40 may be coupled to the accessory rail 30, as shown in FIG. 1. Coupling the accessory 40 to the accessory rail 30 secures the accessory 40 to the accessory rail 30 and limits relative motion therebetween. The accessory 40 may be releasably coupled to the accessory rail 30. For example, the accessory 40 may be connected with a clamp 42, latch, or the like that permits a user to couple and release the accessory 40 by hand and without tooling (e.g., without a screwdriver, wrench, etc.). The accessory 40 may be substantially permanently attached to the accessory rail 30. As used herein, substantially permanently attached means fixed relative to each other and requiring damage or tooling to separate. For example, the accessory 40 may be welded, secured with fasteners or the like that require tooling to remove, etc.

The accessory rail 30 extends from a first end 32a to a second end 32b opposite the first end 32a. A spacing between first end 32a and the second end 32b may be generally equal to a spacing from the first sidewall 18a to the second sidewall 18b, e.g., along the vehicle lateral direction. The accessory rail 30 may have a U-shape between the first end 32a and the second end 32b. For example, the accessory rail 30 may include a first extension 38a that extends perpendicularly or obliquely from the first end 32a and may include a second extension 38b that extends perpendicularly or obliquely from the second end 32b. The accessory rail 30 may further include a main portion 36 that extends perpendicularly or obliquely from the first extension 38a and extends perpendicularly or obliquely from the second extension 38b. The main portion 36 may extend between the first extension 38a to the second extension 38b. The first extension 38a, second extension 38b, and the main portion 36 may provide the U-shape to the accessory rail 30.

The accessory rail 30 includes the first latch 34a at the first end 32a and the second latch 34b at the second end 32b. The first latch 34a and the second latch 34b are configured to releasably couple to the first tie down 20a and/or the second tie down 20b, e.g., the first latch 34a may be releasably coupled to the first tie down 20a and the second latch 34b may be releasably coupled to the second tie down 20b. The first latch 34a and the second latch 34b may include, for example, a hook, a pin, a bolt, a gate, a spring, or other suitable structure for releasably coupling to the first tie down 20a and/or the second tie down 20b, i.e., without damaging the truck bed 12, the accessory rail 30, etc., and without requiring tooling. Coupling the first latch 34a and the second latch 34b to the first tie down 20a and the second tie down 20b limits movement of the accessory rail 30 relative to the truck bed 12. Uncoupling, e.g., releasing, the first latch 34a and the second latch 34b from the first tie down 20a and the second tie down 20b frees movement of the accessory rail 30 relative to the truck bed 12. The first latch 34a and the second latch 34b may generally maintain coupling with the first tie down 20a and the second tie down 20b, e.g., such that actuation of the respective first latch 34a and the second latch 34b by a user is required to release the first latch 34a and the second latch 34b from the first tie down 20a and the second tie down 20b.

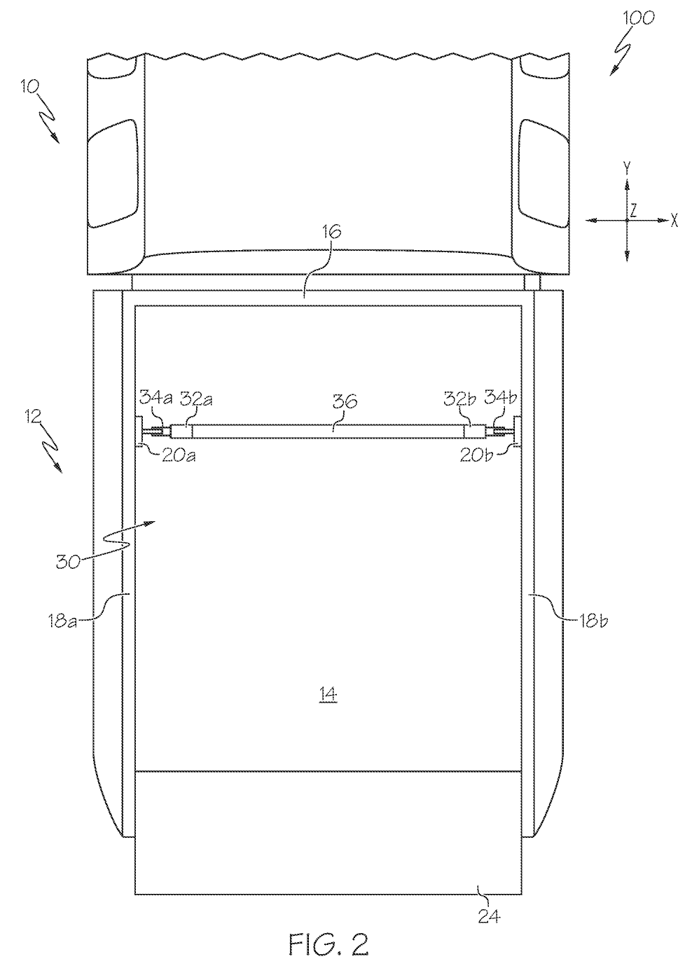

The accessory rail 30 is movable from one or more uninstalled positions (e.g., as shown in FIG. 1) to one or more installed positions (e.g., as shown in FIG. 2-5). For ease of illustration, the accessory 40 is not shown in FIGS. 2-5 (e.g., the accessory 40 is released from the accessory rail 30 and positioned out of view). A user may install the accessory rail 30, i.e., move the accessory rail 30 to the installed position, by coupling the first latch 34a and the second latch 34b to the first tie down 20a and the second tie down 20b, respectively. A user may uninstall the accessory rail 30, i.e., move the accessory rail 30 to the uninstalled position, by releasing the first latch 34a from the first tie down 20a and releasing the second latch 34b from the second tie down 20b.

With reference to FIG. 1, the first latch 34a and the second latch 34b at the uninstalled position are not coupled with the first tie down 20a and the second tie down 20b such that the accessory rail 30 can be moved, e.g., freely, relative to the truck bed 12. The accessory rail 30 at the uninstalled position may be separated from the truck bed 12, e.g., for storage in a garage or the like until a user desires to install the accessory rail 30 to the truck bed 12.

With reference to FIGS. 2-5, the first latch 34a and the second latch 34b are shown coupled with the first tie down 20a and the second tie down 20b at various installed positions such that movement the accessory rail 30 is limited relative to the truck bed 12, and in particular to relative to the first tie down 20a and the second tie down 20b. The accessory rail 30 at the installed position may be disposed in the cargo volume 22, e.g., above the floor 14 and between the first sidewall 18a and the second sidewall 18b. The accessory rail 30 may be movable to different installed positions where the accessory rail 30 is at different locations and/or orientations relative to the truck bed 12. The different installed positions provide flexibility in types of accessories that are usable with the accessory rail 30.

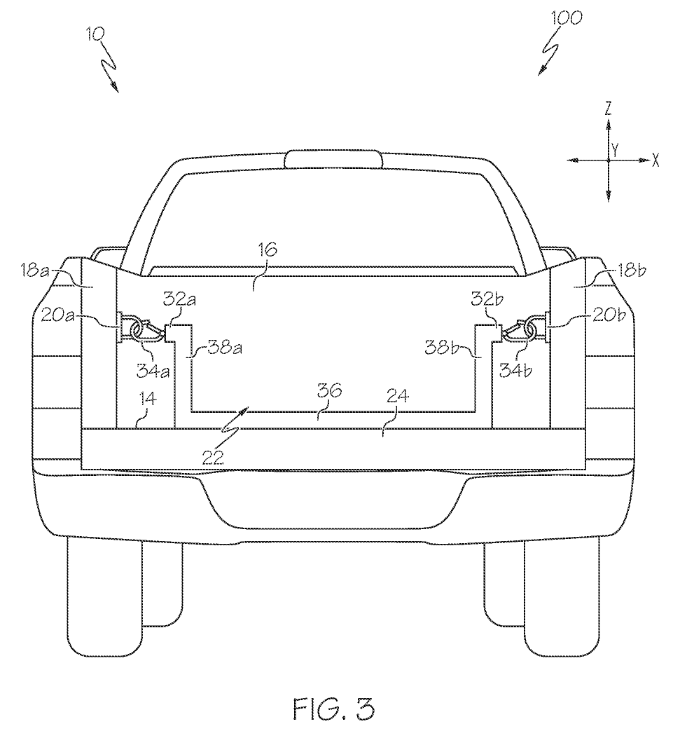

With reference to FIGS. 2 and 3, the accessory rail 30 at one example installed position is shown. At the example installed position of FIGS. 2 and 3, the accessory rail 30 extends downward toward the floor 14 and laterally across the floor 14. As shown, the first extension 38a and the second extension 38b may extend downward from the first end 32a and the second end 32b, e.g., proximate the first sidewall 18a and the second sidewall 18b and generally parallel to the vehicle vertical direction. The main portion 36 may extend laterally along the floor 14 from a bottom end of the first extension 38a to a bottom end of the second extension 38b. As a further example, the accessory rail 30 at the installed position may abut the floor 14, e.g., the main portion 36 may abut the floor 14 as shown in FIG. 3.

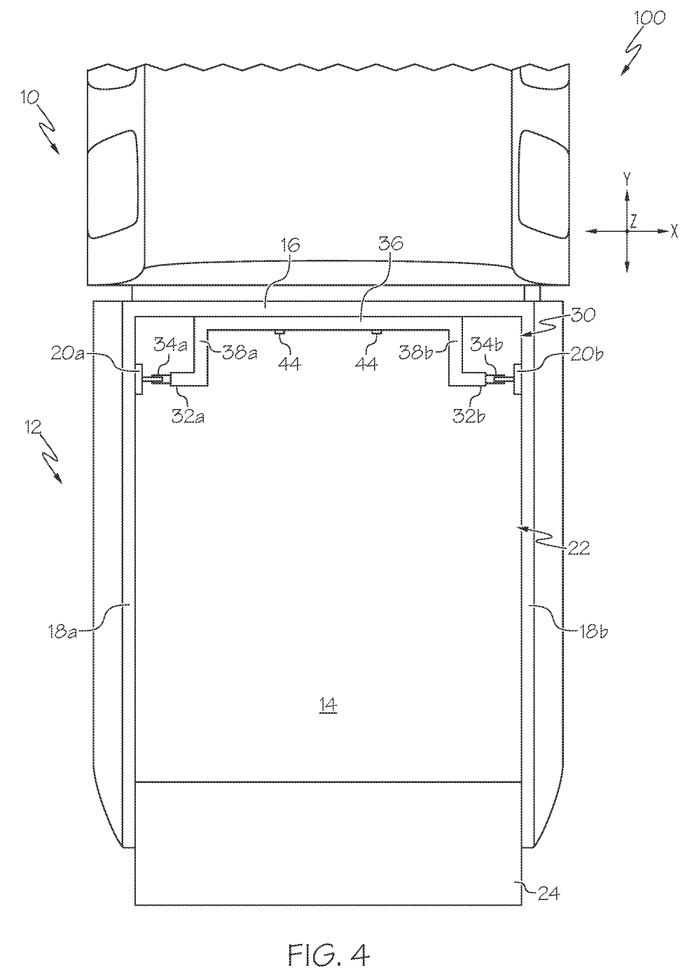

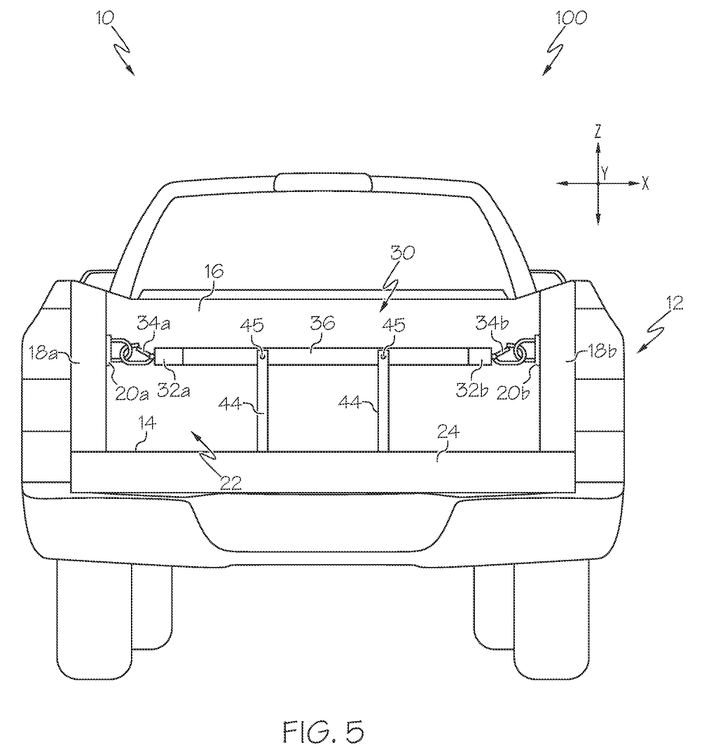

With reference to FIGS. 4 and 5, the accessory rail 30 at another example installed position is shown. At the example installed position of FIGS. 4 and 5, the accessory rail 30 extends forward from the first end 32a and the second end 32b toward the front wall 16 and laterally across the front wall 16. As shown, the first extension 38a and the second extension 38b may extend forward from the first end 32a and the second end 32b, e.g., proximate the first sidewall 18a and the second sidewall 18b and generally parallel to the vehicle longitudinal direction. As a further example, the accessory rail 30 at the installed position may abut the front wall 16, e.g., the main portion 36 may abut the front wall 16 as shown in FIG. 5.

With further reference to FIG. 5, the accessory rail 30 may include one or more supports 44 that support, e.g., bear weight of, the accessory rail 30 at one or more installed positions. For example, supports 44 may be attached to the main portion 36, e.g., fixed via fastener, weld, or the like. The supports 44 may extend, e.g., perpendicularly or obliquely, from the main portion 36. The supports 44 may abut the floor 14 at the installed position, e.g., to provide a normal force to the main portion 36.

The supports 44 may be hingedly connected to the main portion 36, e.g., via a hinge pin 45 or other suitable structure that provides pivotal movement. The supports 44 may pivot between an extended position and a stowed position, e.g., about the hinge pin 45. The supports 44 in the extended position extend away from the main portion 36, e.g., to abut the floor 14 and support the main portion 36 as shown in FIG. 5. The supports 44 in the stowed portion may extend along the main portion 36, e.g., permitting the main portion 36 to abut the floor 14 in other installed positions, such as the installed position shown in FIGS. 2 and 3. The supports 44 in the stowed portion may be parallel with the main portion 36.

As used herein, the singular forms “a,” “an” and “the” include plural referents unless the context clearly dictates otherwise. Thus, for example, reference to “a” component includes aspects having two or more such components, unless the context clearly indicates otherwise.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It is noted that the terms "generally" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An accessory rail mounting system comprising:
a truck bed including a floor, a front wall, a first sidewall, and a second sidewall;
a first tie down fixed to the first sidewall;
a second tie down fixed to the second sidewall; and
an accessory rail having a first end and a second end opposite the first end, the accessory rail having a first latch at the first end and a second latch at the second end, the first latch and the second latch configured to releasably couple to the first tie down and the second tie down to releasably couple the accessory rail to the truck bed.

2. The accessory rail mounting system of claim 1, wherein the accessory rail is movable from an uninstalled position to an installed position, at the uninstalled position the first latch and the second latch are not coupled with the first tie down and the second tie down, and at the installed position the first latch and the second latch are coupled with the first tie down and the second tie down.

3. The accessory rail mounting system of claim 2, further comprising an accessory coupled to the accessory rail.

4. The accessory rail mounting system of claim 3, wherein the accessory is releasably coupled to the accessory rail.

5. The accessory rail mounting system of claim 3, wherein the accessory is a wheel chock.

6. The accessory rail mounting system of claim 3, wherein the accessory is fixed to the accessory rail.

7. The accessory rail mounting system of claim 2, wherein the accessory rail at the installed position abuts the floor.

8. The accessory rail mounting system of claim 2, wherein the accessory rail at the installed position abuts the front wall.

9. The accessory rail mounting system of claim 2, wherein the accessory rail at the installed position extends downward toward the floor and laterally across the floor.

10. The accessory rail mounting system of claim 2, wherein the accessory rail at the installed position extends forward from the first end and the second end toward the front wall and laterally across the front wall.

11. The accessory rail mounting system of claim 10, wherein the accessory rail includes at least one support extending from the accessory rail, the at least one support abutting the floor at the installed position.

12. The accessory rail mounting system of claim 2, wherein the floor, the front wall, the first sidewall, and the second sidewall collectively define a cargo volume, the accessory rail at the installed position is disposed in the cargo volume.

13. The accessory rail mounting system of claim 1, wherein the accessory rail has a U-shape between the first end and the second end.

14. The accessory rail mounting system of claim 1, wherein the first tie down is a loop.

15. The accessory rail mounting system of claim 14, wherein the second tie down is a loop.
